(19) United States
(12) Patent Application Publication
(10) Pub. No.: US 2016/0063378 A1
(43) Pub. Date: Mar. 3, 2016

(54) INTERVAL DISAGGREGATE

(71) Applicants: Kunsoo Park, Seoul (KR); Sang Kyun Cha, Seoul (KR); Chang Bin Song, Seoul (KR); Ki Hong Kim, Seoul (KR); Sunho Lee, Seoul (KR); Cheol Yoo, Seoul (KR)

(72) Inventors: Kunsoo Park, Seoul (KR); Sang Kyun Cha, Seoul (KR); Chang Bin Song, Seoul (KR); Ki Hong Kim, Seoul (KR); Sunho Lee, Seoul (KR); Cheol Yoo, Seoul (KR)

(21) Appl. No.: 14/471,450

(22) Filed: Aug. 28, 2014

(51) Int. Cl. G06N 5/04; G06N 7/00

(52) U.S. Cl. CPC G06N 5/04; G06N 7/005

(57) ABSTRACT

A system includes determination of a total target value associated with N dimension members, determination of a set of historical values for each of the N dimension members, for each of the N dimension members, determination of a prediction interval based on the set of historical values of the dimension member, determination of an N-polytope in N-dimensional space based on the N determined prediction intervals, determination of an (N−1)-polytope of the N-dimensional space in which the sum of the N values of each coordinate of the (N−1)-polytope equals the total desired value, determination of an (N−1)-dimensional intersection of the N-polytope and the (N−1) polytope, and determination of a disaggregation of the total target value among the N dimension members based on the coordinates of the (N−1)-dimensional intersection.

### BACKGROUND

Enterprise software systems receive, generate and store data related to many aspects of a business enterprise. These systems may provide reporting, planning, and/or analysis of the data based on logical entities known as dimensions and measures. Dimensions represent sets of values (i.e., Dimension members) along which an analysis may be performed or a report may be generated (e.g., Country, Year, Product), and measures are indicators, most often numeric, whose values can be determined for a given combination of dimension members. For example, a value of the Sales measure may be determined for bicycles (i.e., a member of the Product dimension) in January (i.e., a member of the Month dimension).

According to one type of business planning, future business targets are defined in order to assist operational planning and to serve as a benchmark against which performance may be measured. Referential disaggregation is one technique used to define future business targets based on prior data.

Table 100 of FIG. 1 presents an example of referential disaggregation. As shown, 2013 revenue for products A, B, and C was 40, 30, and 30, respectively. A business planner has indicated that the target total revenue for 2013 is 110. This target represents an increase of 10% from the 2013 total revenue. According to referential disaggregation, target revenues are calculated for each of products A, B and C by simply increasing each of their 2013 revenues by 10%. Referential disaggregation fails to leverage business intelligence underlying the historical data.

### BRIEF DESCRIPTION OF THE DRAWINGS

FIG. 1 is a tabular representation of values.

FIG. 2 is a block diagram of a system according to some embodiments.

FIG. 3 is a flow diagram of a process according to some embodiments.

FIG. 4 illustrates a linear regression line and prediction interval.

FIG. 5 is a tabular representation of values according to some embodiments.

FIG. 6 illustrates an intersection between an N-dimensional polytope and an (N−1)-dimensional polytope according to some embodiments.

FIG. 7 illustrates determination of an intersecting point between a max-min line and the intersection according to some embodiments.

FIG. 8 illustrates determination of intersecting points between edges of the N-dimensional polytope and the (N−1)-dimensional polytope according to some embodiments.

FIG. 9 is a tabular view of an array according to some embodiments.

FIG. 10 is a dynamic programming table according to some embodiments.

FIG. 11 illustrates a linear regression line and prediction interval.

FIG. 12 is a block diagram of a computing device according to some embodiments.

### DETAILED DESCRIPTION

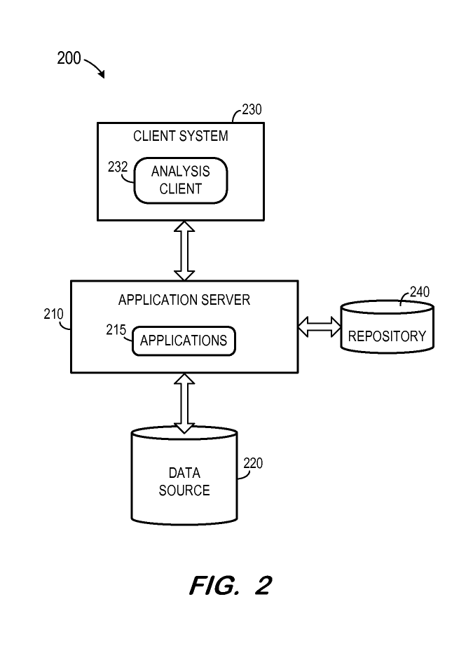

FIG. 2 is a block diagram of system 200 according to some embodiments. FIG. 2 represents a logical architecture for describing processes according to some embodiments, and actual implementations may include more or different components arranged in other manners.

System 200 includes application server 210 to provide data of data source 220 to client system 230. For example, application server 210 may execute one of applications 215 to receive a request for analysis from analysis client 232 executed by client system 230, to query data source 220 for data required by the analysis, receive the data from data source 220, perform the analysis on the data, and return results of the analysis to client system 230.

Data source 220 may comprise any one or more systems to store business data. The data stored in data source 220 may be received from disparate hardware and software systems, some of which are not interoperational with one another. The systems may comprise a back-end data environment employed in a business or industrial context. The data may be pushed to data source 220 and/or provided in response to queries received therefrom.

The data may comprise a relational database, a multi-dimensional database, an eXtendable Markup Language (XML) document, and/or any other structured data storage system. The physical tables of data source 220 may be distributed among several relational databases, multi-dimensional databases, and/or other data sources. For example, data source 220 may comprise one or more OnLine Analytical Processing (OLAP) databases (i.e., cubes). Moreover, the data of data source 220 may be indexed and/or selectively replicated in an index.

Data source 220 may implement an “in-memory” database, in which volatile (e.g., non-disk-based) storage (e.g., Random Access Memory) is used both for cache memory and for storing data during operation, and persistent storage (e.g., one or more fixed disks) is used for offline persistency of data and for maintenance of database snapshots. Alternatively, volatile storage may be used as cache memory for storing recently-used database data, while persistent storage stores data. In some embodiments, the data comprises one or more of conventional tabular data, row-based data stored in row format, column-based data stored in columnar format, and object-based data.

To provide economies of scale, data source 220 may include logical databases of more than one customer, which are programmatically isolated from one another. In this scenario, application server 210 includes mechanisms to ensure that a client accesses only the data that the client is authorized to access.

Client system 230 may comprise one or more devices executing program code of a software application for presenting user interfaces to allow interaction with applications 215 of application server 210. Client system 230 may comprise a desktop computer, a laptop computer, a personal digital assistant, a tablet PC, and a smartphone, but is not limited thereto.

Analysis client 132 may comprise program code of a spreadsheet application, a spreadsheet application with a plug-in allowing communication (e.g. via Web Services) with application server 210, a rich client application (e.g., a Business Intelligence tool), an applet in a Web browser, or any other application to perform the processes attributed thereto herein.

Repository 240 stores metadata and data for use by application server 210. The metadata may specify a logical schema of data source 220 (i.e., dimensions and measures), which may be used by application server 210 to query data source 220. The metadata may also define users, workspaces, data source connections, and dimension member hierarchies.

Although system 200 has been described as a distributed system, system 200 may be implemented in some embodiments by a single computing device. For example, both client system 230 and application server 210 may be embodied by an application executed by a processor of a desktop computer, and data source 220 may be embodied by a fixed disk drive within the desktop computer.

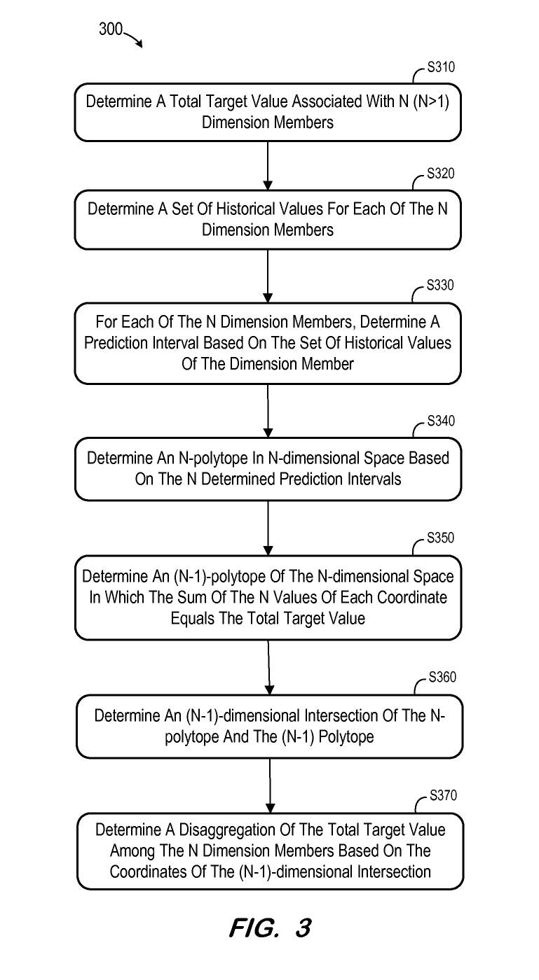

FIG. 3 comprises a flow diagram of process 300 according to some embodiments. In some embodiments, various hardware elements of system 200 execute program code to perform process 300. In some embodiments, hard-wired circuitry may be used in place of, or in combination with, program code for implementation of processes according to some embodiments. Embodiments are therefore not limited to any specific combination of hardware and software.

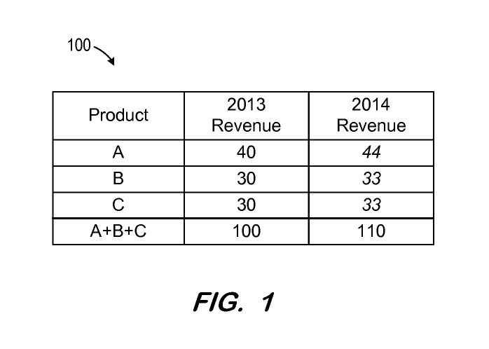

Prior to process 300, a user may operate analysis client 232 to access a planning interface, such as a planning Web page. The user interacts with the interface to input a total target value associated with two or more (hereinafter, “N”) dimension members. For example, with reference to FIG. 1, a user may manipulate a user interface of analysis client 232 to specify a total target 2014 revenue for products A, B and C of 110. Any querying/reporting/analysis paradigm that is or becomes known may be used to specify the total target value and the associated dimension member(s) according to some embodiments. In some examples, the user drags and drops the dimension members from a list into a workspace of a user interface.

The specified dimension members and total target value are determined at S310. For example, the specified dimension members and total target value may be received by an application 215 of application server 210 at S310. Next, at S320, a set of historical values is determined for each of the dimension members. According to some embodiments, application server 210 may query data source 220 for these values (e.g., using metadata of repository 140). Continuing the above example, application server 210 may query data source 220 for revenue values for each of products A, B and C for each of several years.

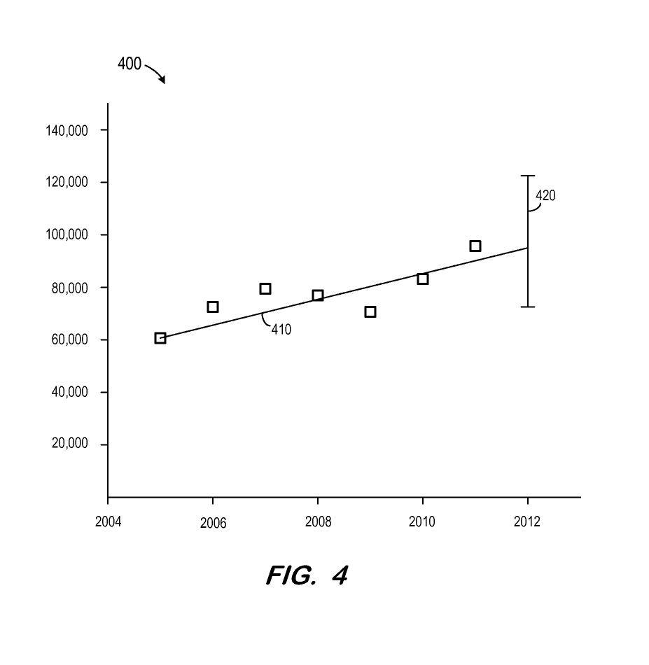

A prediction interval is determined for each of the N dimension members based on its set of historical values at S330. Linear regression with least squares fitting is a known operation to determine such a prediction interval. For example, FIG. 4 shows linear regression line 410 for sample sales data from 2005 to 2011, along with 90% prediction interval 420 for 2012. Prediction interval 420 represents a range in which the 2012 point of 2012 will fall 90% of time). Prediction interval 420 reflects not only the slope of linear regression 410, but also variations of the data points. The smaller the variations, the narrower the prediction interval. Embodiments are not limited to linear regression or to any particular percentage prediction interval.

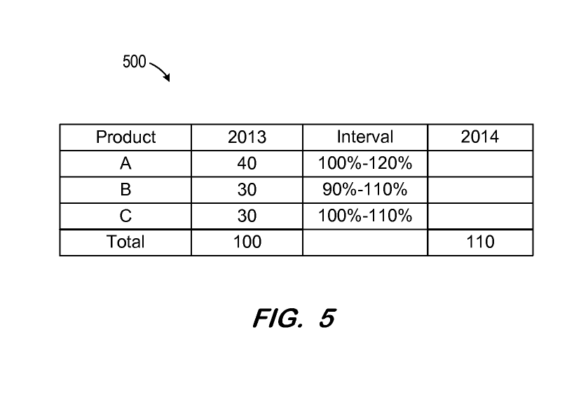

Table 500 of FIG. 5 illustrates some of the determinations of process 300 after completion of S330. Total target value 110 is shown, as well as 90% prediction intervals for 2014 revenue values of each of products A, B and C. In real numbers, the prediction intervals for products A, B and C are 40-48, 27-33 and 30-33, respectively.

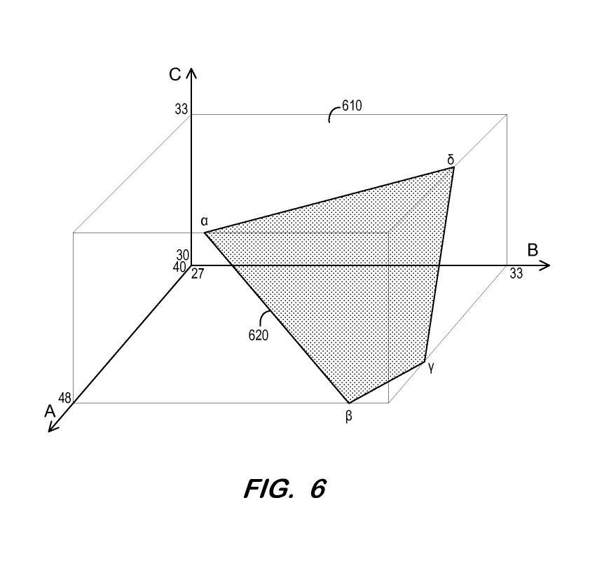

At S340, an N-polytope in N-dimensional space is determined based on the N determined prediction intervals. A polytope is a geometric object with flat sides and any number of dimensions. FIG. 6 illustrates 3-polytope 610 in 3-dimensional space based on the determined prediction intervals (40-48, 27-33 and 30-33) of products A, B and C. The present example involves a three-dimensional polytope to assist in comprehension, but embodiments are not limited thereto.

Next, at S350, an (N−1) polytope of the N-dimensional space is determined, in which the sum of the N values of each coordinate of the (N−1) polytope equals the total desired value. According to the present example, S350 includes determination of a plane in which each coordinate is a solution of A+B+C=110.

An intersection of the (N−1) polytope and the N-polytope is determined at S360. FIG. 6 illustrates intersection 620 according to the present example. Each coordinate of intersection 620 is a solution of A+B+C=110, and each coordinate includes values for dimension members A, B and C which fall within the prediction interval determined for each dimension member.

Accordingly, a disaggregation of the total target value among the N dimension members is determined based on the coordinates of the intersection at S370. In some examples, an appropriate disaggregation is determined to be a midpoint of the intersection. The midpoint may be defined in various manners, including as the point where a min-max line intersects the intersection, the center of mass of the intersection, the centroid of the vertices of the intersection, and the point whose probability is maximized in the linear regression models.

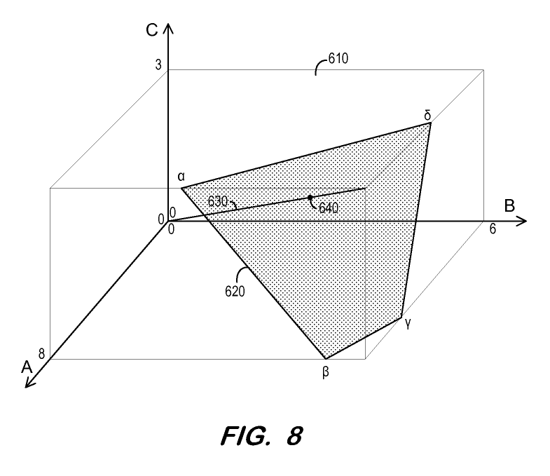

The min (max) point is the point of the N-polytope defined by the prediction intervals which has the minimum (maximum) value in each axis, and the min-max line is a line between the min point and the max point. FIG. 8 illustrates min-max line 630 in the present 3-dimensional example. The point where the min-max line and the intersection intersect will be called the intersecting point, depicted by point 640 of FIG. 8. The center of mass is the center point of the distribution of mass in the intersection. The centroid of the intersection is simply the average of the vertices, and the point whose probability is maximized is called the mode.

Let Min=(p₁, . . . , p₃) and Max=(q₁, . . . , q₃) be the min point and the max point of the rectilinear box, respectively. All intervals (p₁,q₁), . . . , (p_{d},q_{d}) are specified by Min and Max. Let T be the target value of interval disaggregation. In the example of FIG. 8, Min=(40,27,30), Max=(48,33,33), and T=110.

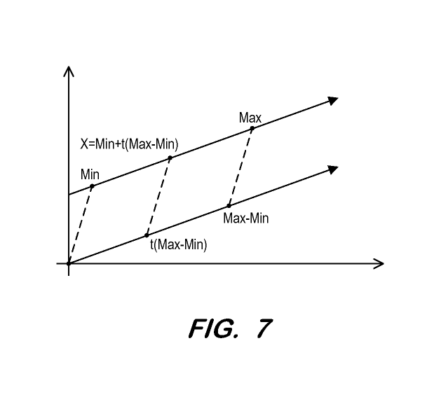

In order to determine the intersecting point at S370, the min-max line, which passes through Min and Max, is denoted by a vector X=Min+t(Max−Min) for a real number t, i.e., X=(p₁+t(q₁−p₁), . . . , p_{d}+t(q_{d}−p_{d})). FIG. 7 illustrates this case in two dimensions. The equation of the N−1 polytope determined at S350 is a₁+ . . . +a_{d}=T for a d-dimensional point (a₁, . . . , a_{d}). To find the intersecting point, the coordinates of X are plugged into the equation of the N−1 polytope, which results in (p₁+ . . . +p_{d})+t((q₁+ . . . +q_{d})−(p₁+ . . . +p₆))=T. Hence,

t=T−(p₁+ . . . +p_{d})/(q₁+ . . . +q_{d})−(p₁+ . . . +p_{d}).

Substituting the value oft for X produces the intersecting point. According to the present example, X=(40+8t, 27+6t, 30+3t),

$$t - \frac{13}{17} ,$$

and the intersecting point is (46.1, 31.6, 32.3). The disaggregation is therefore A=46.1, B=31.6 and C=32.3.

Another way to view the above computation is as follows. Given a vector (a₁, . . . , a_{d}) in d dimensions, its Manhattan distance (also known as L₁ distance) is a₁+ . . . +a_{d}, while its Euclidean distance is \sqrt{a₁²+ . . . +a_{d}²}. The line segment between Min and Max (i.e., vector Max−Min) has Manhattan distance (q₁+ . . . +q_{d})−(p₁+ . . . +p_{d}), and the line segment between Min and the intersecting point has Manhattan distance T−(p₁+ . . . +p_{d}) because the Manhattan distance of the intersecting point is T and that of Min is p₁+ . . . +p_{d}. Hence, the intersecting point is the point in the line segment between Min and Max whose relative distance from Min is

$$t = \frac{T - ( {p}_{1} + … + {p}_{d} )}{( {q}_{1} + … + {q}_{d} ) - ( {p}_{1} + … + {p}_{d} )} ,$$

i.e., it is Min+t(Max−Min).

Alternatively, to find the center of mass and the centroid at S370, the vertices of the intersection are determined. The vertices of the intersections are the intersections of the (N−1)-polytope of S350 and the edges of the N-polytype of S340. Initially, as shown in FIG. 8, it is assumed that the min point of the rectilinear box is (0,0,0). After finding intersections with this assumption, the correct intersections may be determined by adding the corresponding min point to each intersection.

There are four edges parallel to the A-axis in FIG. 8, and the value of a in these edges satisfies 0≦a≦8. Since the (N−1)-polytype satisfies a+b+=13, the intersections with these edges satisfy b≦b+c≦13. Since the value of b is either 0 or 6 and the value of c either 0 or 3 in these edges, the combinations of these values which satisfy 5≦b+c≦13. are determined. The combinations are b=6, c=0, which results in intersection γ′=: (7,6,0), (i.e., γ=(47,33,30) after adding the min point), and b=6, c=3, which results in δ′=(4,6,3), (i.e., δ=(44,33,33) after adding the min point).

In general, let (r₁, r₂, . . . , r_{d}) be the max point of the N-polytype, when the min point is (0, . . . , 0), i.e., rᵢ=qᵢ−pᵢ for 1≦i≦d. To find the intersections on the edges parallel to the A-axis, find all subsets of {r₂, . . . , r_{d}} whose sum is between T′−r₁ and T′, where T′=T−(p₁+−+p_{d}). Similarly, the intersections on the edges parallel to the B-axis, etc. may be determined. The following two algorithms may be executed to determine the intersections for all axes at the same time.

The first algorithm computes all possible subsets of {r₁, . . . , r_{d}} and checks if each subset can produce intersections. Let Sum[0 . . . 2^{d}−1] be an array such that Sum[i] is the sum of the subset represented by the binary notation of i, i.e., rₖ is in the subset if the k-th rightmost bit of i is 1. For example, if i=110₂ in FIG. 5, Sum[6]=9 because 110₂ represents (r₂,r₂) TA where r₂=6 and r₃=3. Array Sum can be computed as follows.

Sum[0]=0

for(k=1 to d)
for(j=0 to 2^{k-1}−1)
   Sum[2^{k-1}+j]=Sum[j]+rₖ

From each entry Sum[i], intersections are determined by the following Cases. Let maxr=_{1≦k≦d}^{max}[(r)ₖ].

Sum[i]=T′: the subset represented byⁱ is an intersection.

T′−maxr<Sum[i]<T′: for each dimension 1≦k≦d, if the k-th rightmost bit of i is 0 and Sum[i]>T′−rₖ, output intersection (b₁, . . . , b_{d}), where bᵢ=r₁ if i≠k and the j-th rightmost bit of i is 1; bᵢ=0 if j≠k and the j-th rightmost bit of i is 0; bⱼ=T′−Sum[i] if j=k. (If Sum[i]=T′−rₖ; there is an intersection, but this intersection will be found in Case 1 of some other entry).

Sum[i]≦T′−maxr: output no intersections. (If Sum[i]=T′−maxr, again this intersection will be found in Case 1 of some other entry).

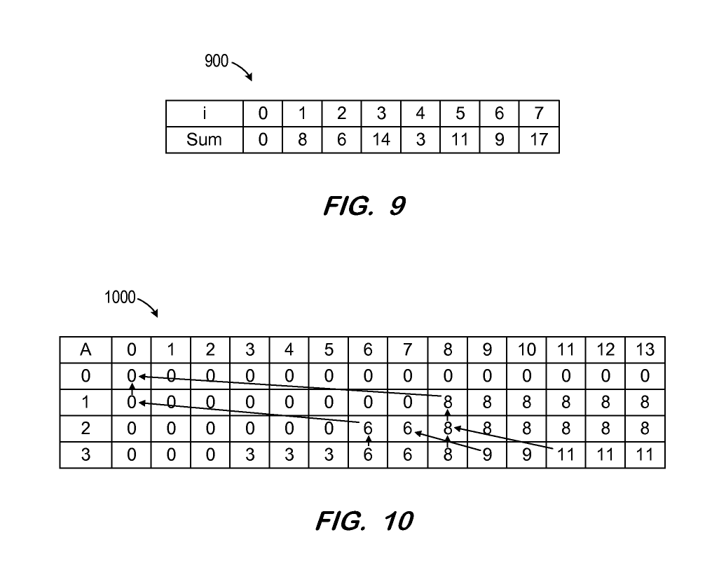

For the example in FIG. 5, r₁=8, r₂=6, r₃=3, and T′=13. Array Sum for this example is shown in table 900 of FIG. 9. Since maxr=8, Sum[2] is in Case 2, and it produces intersection γ′=(7,6,0).

Let S be the number of intersections, and P the number of entries such that T′−maxr<Sum[i]≦T′. Computing Sum takes O(2^{d}) time. For each entry such that T′−maxr<Sum[i]≦T′, the three cases above take at least O(d) time, and if there are many intersections from the entry then Case 2 takes O(d) time for each intersection. Therefore, the time complexity of the first algorithm is O(2^{d}+d·P+d·S).

The second algorithm uses dynamic programming Let A(i,w) be the maximum value ≦w that can be obtained with r₁, . . . , r₁. A dynamic programming recurrence for A(i,w) is:

$$A ( i , w ) = \{ \begin{matrix}0 & if i = 0 or w = 0 \\ A ( i - 1 , w ) & if i > 0 , w > 0 , and {r}_{1} > w \\ max \{ \begin{matrix}A ( i - 1 , w ) \\ A ( i - 1 , w - {r}_{i} ) + {r}_{i}\end{matrix} & \begin{matrix}if i > 0 , w > 0 \\ and {r}_{i} \leq w\end{matrix}\end{matrix} .$$

All entries of table A(0 . . . d, 0 . . . T′) are computed by the recurrence above, and then all paths from the entries A(d,T′−maxr+1 . . . T′) to A(0,0) are found by backtracking. Each path corresponds to a subset of {r₁, . . . r_{d}} whose sum is >T′−maxr. Hence, the number of distinct paths is exactly P. For each path, Cases 1 and 2 of the first algorithm are performed, where Sum[i] is now the sum of the subset corresponding to the path. The time complexity of the second algorithm is O(d·T′+d·P+d·S), since computing table A takes O(d·T′) time and backtracking O(d·P).

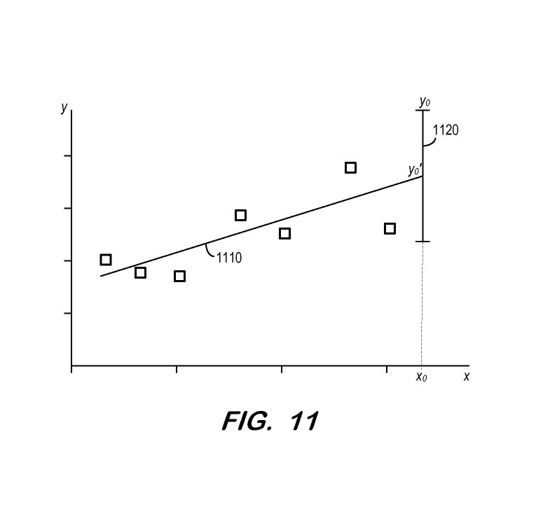

For the example of FIG. 8, dynamic programming table A is shown in table 1000 of FIG. 10, where there are four backtracking paths, each of which produces an intersection (e.g., the backtracking path from A(3,6) produces intersection γ′=(7,6,0)). If we backtrack from A(3,7), we arrive at (0,1). Thus, if there are identical values in A(d,T′−maxr+1 . . . T′), we backtrack only from the leftmost one, which leads to A(0,0).

The first algorithm may be useful when N is small whereas the second may be useful when the target value T′ is moderate.

Once all vertices of the intersection are found by one of the two algorithms above, the centroid, which is the average of the vertices, can be easily computed. For instance, in the FIG. 6 example, the centroid is

$$\frac{α + β + γ + δ}{4} = ( 46.75 , 31.75 , 31.5 ) .$$

To find the center of mass, the intersection is divided into simplexes (e.g., a simplex in two dimensions is a triangle, and a tetrahedron in three dimensions) by using Delaunay triangulation. The center of mass of a simplex is the centroid of its vertices, and the center of mass of the feasible polytope is the weighted sum of the centers of mass of the simplexes where the weights are the volumes of the simplexes. For the example of FIG. 6, the center of mass is (46.6,31.6,31.8).

In order to determine the mode at S370, the value of the response variable yₒ at a future value xₒ is determined for each of N dimension members. As described with respect to S330, a linear regression may be determined for each of N dimension members. Let y=α+βx be the linear equation of line 1110 obtained by linear regression on a sample of n points for a dimension member. See FIG. 11, where n=7. Let yₒ⁷−α+βxₒ. The value of yₒ at xₒ follows a t-distribution whose mean is yₒ′. If pdf(•) is the probability density function of the t-distribution with n−2 degrees of freedom, the probability density function for yₒ is

$$p d f ( \frac{{y}_{0} - {y}_{0}^{′}}{\sqrt{{MS}_{Res} ( 1 + \frac{1}{n} + \frac{{( {x}_{0} - \overline{x} )}^{2}}{{S}_{xx}} )}} ) ,$$

where MS_{REs}, x̅, sₓₓ are values computed from the n sample points.

Let yᵢ, 1≦1≦d, be the response variable (yₒ in the previous paragraph) in the i-th dimension at the future value xₒ. Let pdfᵢ(yᵢ) be the probability density function for yᵢ. If we assume for simplicity that the d dimensions of interval disaggregation are independent, the mode is a point (a₁, . . . , a_{d}) such that pdfᵢ(aᵢ)× . . . ×pdf_{d}(a_{d}) is maximized.

A user may desire to adjust disaggregated values after interval disaggregation. During such adjusting, the user may fix some one or more of the values and want to see the remaining values determined by interval disaggregation. For the disaggregated values in table 500, the user may, for example, fix the value of product group A to 47 and request determination of the values of product groups B and C by interval disaggregation (Table 5).

Accordingly, the above-described three-dimensional interval disaggregation with total target value of 110 becomes a two-dimensional interval disaggregation in which Min=(27,30), Max=(33,33), and the total target value is 110−47=63. The two-dimensional interval disaggregation can be solved for each of the four above-described midpoints. For example, the intersecting point may be computed as follows: Max−Min=(6, 3), which has Manhattan distance 9. Since the Manhattan distance of the intersecting point is 63 and that of Min is 57, the intersecting point has relative distance 6/9 from Min, and it is

$$Min + ( 6 , 3 ) \cdot \frac{6}{9} = ( 31 , 32 ) .$$

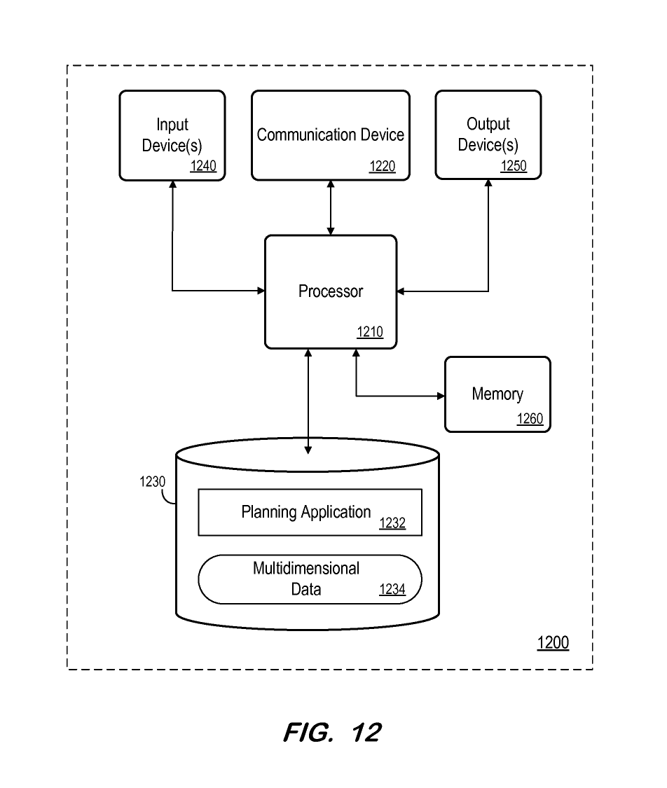

FIG. 12 is a block diagram of apparatus 1200 according to some embodiments. Apparatus 1200 may comprise a general-purpose computing apparatus and may execute program code to perform any of the functions described herein. Apparatus 1200 may comprise an implementation of one or more elements of system 200, such as application server 210. Apparatus 1200 may include other unshown elements according to some embodiments.

Apparatus 1200 includes processor 1210 operatively coupled to communication device 1220, data storage device 1230, one or more input devices 1240, one or more output devices 1250 and memory 1260. Communication device 1220 may facilitate communication with external devices, such as application server 110. Input device(s) 1240 may comprise, for example, a keyboard, a keypad, a mouse or other pointing device, a microphone, knob or a switch, an infra-red (IR) port, a docking station, and/or a touch screen. Input device(s) 1240 may be used, for example, to manipulate graphical user interfaces and to input information into apparatus 1200. Output device(s) 1250 may comprise, for example, a display (e.g., a display screen) a speaker, and/or a printer.

Data storage device 1230 may comprise any device, including combinations of magnetic storage devices (e.g., magnetic tape, hard disk drives and flash memory), optical storage devices, Read Only Memory (ROM) devices, etc., while memory 1260 may comprise Random Access Memory (RAM).

Planning application 1232 of data storage device 1230 may comprise program code executable by processor 1210 to provide any of the functions described herein, including but not limited to process 300. Multidimensional data 1234 may store values associated with dimension members as described herein, in any format that is or becomes known. Multidimensional data 1234 may also alternatively be stored in memory 1260. Data storage device 1230 may also store data and other program code for providing additional functionality and/or which are necessary for operation thereof, such as device drivers, operating system files, etc.

Other topologies may be used in conjunction with other embodiments. Moreover, each system described herein may be implemented by any number of computing devices in communication with one another via any number of other public and/or private networks. Two or more of such computing devices of may be located remote from one another and may communicate with one another via any known manner of network(s) and/or a dedicated connection. Each computing device may comprise any number of hardware and/or software elements suitable to provide the functions described herein as well as any other functions. For example, any computing device used in an implementation of system 200 may include a processor to execute program code such that the computing device operates as described herein.

All systems and processes discussed herein may be embodied in program code stored on one or more computer-readable non-transitory media. Such media non-transitory media may include, for example, a fixed disk, a floppy disk, a CD-ROM, a DVD-ROM, a Flash drive, magnetic tape, and solid state RAM or ROM storage units. Embodiments are therefore not limited to any specific combination of hardware and software.

The embodiments described herein are solely for the purpose of illustration. Those in the art will recognize other embodiments may be practiced with modifications and alterations limited only by the claims.

What is claimed is:

1. A method implemented by a computing system in response to execution of program code by a processor of the computing system, the method comprising:
determining a total target value associated with N dimension members;
determining a set of historical values for each of the N dimension member;
for each of the N dimension members, determining a prediction interval based on the set of historical values of the dimension members;
determining an N-polytope in N-dimensional space based on the N determined prediction intervals;
determining an (N−1)-polytope of the N-dimensional space in which the sum of the N values of each coordinate of the (N−1)-polytope equals the total desired value;
determining an (N−1)-dimensional intersection of the N-polytope and the (N−1) polytope; and
determining a disaggregation of the total target value among the N dimension members based on the coordinates of the (N−1)-dimensional intersection.

2. A method according to claim 1, wherein determining the disaggregation of the total target value comprises:
determining a center of mass of the (N−1)-dimensional intersection.

3. A method according to claim 2, wherein determining the center of mass of the (N−1)-dimensional intersection comprises:
determining intersections between the (N−1)-dimensional intersection and edges of the N-polytope.

4. A method according to claim 1, wherein determining the disaggregation of the total target value comprises:
determining a centroid of the (N−1)-dimensional intersection.

5. A method according to claim 4, wherein determining the centroid of the (N−1)-dimensional intersection comprises:
determining intersections between the (N−1)-dimensional intersection and edges of the N-polytope.

6. A method according to claim 1, wherein determining the disaggregation of the total target value comprises:
determining a coordinate of the (N−1)-dimensional intersection associated with a maximum probability based on N determined prediction intervals.

7. A method according to claim 1, wherein determining the disaggregation of the total target value comprises:
determining a line between a minimum coordinate associated with a minimum value of each of the N determined prediction intervals and a maximum coordinate associated with a maximum value of each of the N determined prediction intervals; and
determining an intersection point between the line and the (N−1)-dimensional intersection.

8. A non-transitory medium storing processor-executable program code, the program code executable by a processor of a computing device to:
determine a total target value associated with N dimension members;
determine a set of historical values for each of the N dimension members;
for each of the N dimension members, determine a prediction interval based on the set of historical values of the dimension member;
determine an N-polytope in N-dimensional space based on the N determined prediction intervals;
determine an (N−1)-polytope of the N-dimensional space in which the sum of the N values of each coordinate of the (N−1)-polytope equals the total desired value;
determine an (N−1)-dimensional intersection of the N-polytope and the (N−1) polytope; and
determine a disaggregation of the total target value among the N dimension members based on the coordinates of the (N−1)-dimensional intersection.

9. A medium according to claim 8, wherein determination of the disaggregation of the total target value comprises:
determination of a center of mass of the (N−1)-dimensional intersection.

10. A medium according to claim 9, wherein determination of the center of mass of the (N−1)-dimensional intersection comprises:
determination of intersections between the (N−1)-dimensional intersection and edges of the N-polytope.

11. A medium according to claim 8, wherein determination of the disaggregation of the total target value comprises:
determination of a centroid of the (N−1)-dimensional intersection.

12. A medium according to claim 11, wherein determination of the centroid of the (N−1)-dimensional intersection comprises:
determination of intersections between the (N−1)-dimensional intersection and edges of the N-polytope.

13. A medium according to claim 8, wherein determination of the disaggregation of the total target value comprises:
determination of a coordinate of the (N−1)-dimensional intersection associated with a maximum probability based on N determined prediction intervals.

14. A medium according to claim 8, wherein determination of the disaggregation of the total target value comprises:
determination of a line between a minimum coordinate associated with a minimum value of each of the N determined prediction intervals and a maximum coordinate associated with a maximum value of each of the N determined prediction intervals; and
determination of an intersection point between the line and the (N−1)-dimensional intersection.

15. A system comprising:
a memory storing processor-executable program code; and
a processor to execute the processor-executable program code in order to cause the computing device to:
determine a total target value associated with N dimension members;
determine a set of historical values for each of the N dimension members;
for each of the N dimension members, determine a prediction interval based on the set of historical values of the dimension member;
determine an N-polytope in N-dimensional space based on the N determined prediction intervals;
determine an (N−1)-polytope of the N-dimensional space in which the sum of the N values of each coordinate of the (N−1)-polytope equals the total desired value;
determine an (N−1)-dimensional intersection of the N-polytope and the (N−1) polytope; and
determine a disaggregation of the total target value among the N dimension members based on the coordinates of the (N−1)-dimensional intersection.

16. A system according to claim 15, wherein determination of the disaggregation of the total target value comprises:
determination of a center of mass of the (N−1)-dimensional intersection.

17. A system according to claim 15, wherein determination of the disaggregation of the total target value comprises:
determination of a centroid of the (N−1)-dimensional intersection.

18. A system according to claim 17, wherein determination of the centroid of the (N−1)-dimensional intersection comprises:
determination of intersections between the (N−1)-dimensional intersection and edges of the N-polytope.

19. A system according to claim 15, wherein determination of the disaggregation of the total target value comprises:
determination of a coordinate of the (N−1)-dimensional intersection associated with a maximum probability based on N determined prediction intervals.

20. A system according to claim 15, wherein determination of the disaggregation of the total target value comprises:
determination of a line between a minimum coordinate associated with a minimum value of each of the N determined prediction intervals and a maximum coordinate associated with a maximum value of each of the N determined prediction intervals; and
determination of an intersection point between the line and the (N−1)-dimensional intersection.
